(19) United States
(12) Patent Application Publication
(10) Pub. No.: US 2020/0130990 A1
(43) Pub. Date: Apr. 30, 2020

(54) METHODS AND APPARATUSES FOR CONFIGURING WIRELESS DEVICES IN AN ELEVATOR SYSTEM

(71) Applicant: KONE CORPORATION, Helsinki (FI)

(72) Inventors: Matti MUSTONEN, Helsinki (FI); Matti LAAKSO, Helsinki (FI)

(73) Assignee: KONE CORPORATION, Helsinki (FI)

(21) Appl. No.: 16/687,113

(22) Filed: Nov. 18, 2019

Related U.S. Application Data
(63) Continuation of application No. PCT/FI2017/050482, filed on Jun. 27, 2017.

(51) Int. Cl. B66B 1/46; B66B 1/28; B66B 1/34; B66B 13/14; H04B 17/318; H04W 48/08

(52) U.S. Cl. CPC B66B 1/466; B66B 1/28; B66B 1/3461; B66B 13/143; B66B 2201/4638; B66B 1/468; H04B 17/318; H04W 48/08; B66B 2201/4653; B66B 1/3492

(57) ABSTRACT

According to an aspect, there are provided methods and apparatuses for configuring wireless devices in an elevator system. According to an aspect, an elevator car is caused to perform a travel in an elevator shaft. Wireless signal strength values and a device identifier associated with each detected wireless device are recorded based on wireless signals from the wireless devices at landing floors with an elevator car mounted wireless device during the travel. Data is received from the elevator car mounted wireless device, the data comprising for each detected wireless device the device identifier of the detected wireless device and data associated with the wireless signal strength values of the detected wireless device. Each detected wireless device at the landing floors is associated with a specific landing floor based on the data received from the elevator car mounted wireless device.

### CROSS REFERENCE TO RELATED APPLICATIONS

This application is a Continuation of PCT International Application No. PCT/FI2017/050482 filed on Jun. 27, 2017, which is hereby expressly incorporated by reference into the present application.

### BACKGROUND

Wireless devices, for example, landing call stations (LCS) and hall lantern indicators (HLI) in an elevator system need to be configured before they can be taken into use as they do not possess built-in information about the physical location properties, such as 1) in which floor the wireless device is physically located or 2) at which side of the elevator the wireless device is physically located.

One solution for the configuration of the wireless devices is to perform the configuration manually. In the manual configuration, a technician uses a mobile device and configures each wireless device separately and locally with the mobile device using a wired or a short range wireless connection. The configuration information then maps a wireless device to a specific floor and optionally also to a specific side of the elevator. Then the wireless device communicates with a controller and the configuration information (floor, side and device identifier) is sent from the wireless device to the controller. After the configuration, it is possible to determine that “the elevator needs to go to floor 7 and open B side door as the call was received from a wireless device with an identifier 0x12345667 that is mapped to floor 7, B side”.

The above disclosed solution is, however, time consuming and error prone. Further, the configuration process is time consuming as each floor and possibly each side has to be visited separately.

Thus, it would be beneficial to have a solution that would alleviate at least one of these drawbacks.

### SUMMARY

A solution is provided that automates the configuration process. The solution uses wireless devices in the elevator car and landing floors and signal attenuation properties of wireless signals.

According to a first aspect of the invention, there is provided an elevator controller of an elevator system. The elevator controller comprises at least one processing unit and at least one memory, wherein the at least one memory stores program instructions that, when executed by the at least one processing unit, cause the elevator controller to cause an elevator car to perform a travel in an elevator shaft; cause recording of wireless signal strength values and a device identifier associated with each detected wireless device based on wireless signals from the wireless devices at landing floors with an elevator car mounted wireless device during the travel; receive data from the elevator car mounted wireless device, the data comprising for each detected wireless device the device identifier of the detected wireless device and data associated with the wireless signal strength values of the detected wireless device; and associate each detected wireless device at the landing floors with a specific landing floor based on the data received from the elevator car mounted wireless device. This enables a solution to perform the configuration process (i.e. associating the wireless devices with correct floor information) accurately, quickly and efficiently.

In an embodiment, the at least one memory stores program instructions that, when executed by the at least one processing unit, cause the elevator controller to cause the elevator car to stop at locations corresponding to at least some of the landing floors during the travel. By stopping at locations corresponding to at least some of the landing floors during the travel may improve the accuracy of detecting signals from the wireless devices.

In an embodiment, additionally or alternatively, the at least one memory stores program instructions that, when executed by the at least one processing unit, cause the elevator controller to cause the elevator car to open at least one door at each stop. Opening a door or doors may improve the accuracy of detecting signals from the wireless devices.

In an embodiment, additionally or alternatively, the at least one memory stores program instructions that, when executed by the at least one processing unit, cause the elevator controller to cause the elevator car to open its doors at a first side of the elevator car; cause the recording of the wireless signals at a time when the doors are open at the first side; cause the elevator car to close its doors at the first side; cause the elevator car to open its doors at a second side of the elevator car; cause the recording of the wireless signals at a time when the doors are open at the second side; and cause the elevator car to close its doors at the second side. Opening a door or doors may improve the accuracy of detecting signals from the wireless devices.

In an embodiment, additionally or alternatively, the at least one memory stores program instructions that, when executed by the at least one processing unit, cause the elevator controller to cause the elevator car to perform the travel in the elevator shaft without opening elevator doors during the travel. This enables a solution to perform the configuration process quickly and efficiently as there is no need to open door during the travel.

In an embodiment, additionally or alternatively, the data associated with the wireless signal strength values of the detected wireless device comprises a timestamp associated with the maximum signal strength value of the wireless signal strength values, and wherein the at least one memory stores program instructions that, when executed by the at least one processing unit, cause the elevator controller to determine the location of the elevator car in the elevator shaft based on the timestamp; and associate the detected wireless device with a landing floor corresponding to the location of the elevator car. This enables an efficient and simple solution as the elevator controller uses only the timestamp to associate the detected wireless device with a correct landing floor.

In an embodiment, additionally or alternatively, the data associated with the wireless signal strength values of the detected wireless device comprises a set of wireless signal strength value and timestamp pairs, and wherein the at least one memory stores program based on the timestamp instructions that, when executed by the at least one processing unit, cause the elevator controller to determine the maximum wireless signal strength value based on the wireless signal strength values; determine the location of the elevator car in the elevator shaft based on the timestamp corresponding to the maximum wireless signal strength value; and associate the detected wireless device with a landing floor corresponding to the location of the elevator car. This enables an efficient and simple solution as the elevator car mounted wireless device needs to forward the wireless signal strength value and timestamp pairs to the elevator controller without analyzing them.

In an embodiment, additionally or alternatively, the data associated with the wireless signal strength values of the detected wireless device comprises wireless signal strength values recorded for the detected wireless device and floor information associated with the recorded wireless signal strength values, and wherein the at least one memory stores program instructions that, when executed by the at least one processing unit, cause the elevator controller to determine the maximum wireless signal strength value based on the wireless signal strength values; and associate the detected wireless device with a landing floor based on the floor information associated with the maximum wireless signal strength value. This enables a solution to perform the configuration process (i.e. associating the wireless devices with correct floor information) accurately, quickly and efficiently.

In an embodiment, additionally or alternatively, the at least one memory stores program instructions that, when executed by the at least one processing unit, cause the elevator controller to cause the wireless devices to operate in a configuration mode during the travel, wherein in the configuration mode a device identifier associated with each wireless device is transmitted. This enables a solution where configuration of the wireless device can be performed at a desired point of time.

In an embodiment, additionally or alternatively, the elevator car mounted wireless device comprises a car operating panel.

In an embodiment, additionally or alternatively, the wireless devices comprise at least one of a landing call station, a hall lantern indicator and a display.

In an embodiment, additionally or alternatively, the at least one memory stores program instructions that, when executed by the at least one processing unit, cause the elevator controller to configure the wireless devices to use a specific time slot or frequency in transmitting wireless signals. This enables a solution that may improve accuracy of the configuration process as each wireless device uses a dedicated time slot or frequency.

According to a second aspect of the invention, there is provided an elevator car mounted apparatus. The elevator car mounted apparatus comprises at least one processing unit and at least one memory, wherein the at least one memory stores program instructions that, when executed by the at least one processing unit, cause the apparatus to receive, from an elevator controller, an instruction to record wireless signals transmitted from the wireless devices at landing floors; record wireless signal strength values and a device identifier associated with each detected wireless device based on wireless signals from the wireless devices during a travel of the elevator car in an elevator shaft; and transmit data to an elevator controller, the data comprising for each detected wireless device the device identifier of the detected wireless device and data associated with the wireless signal strength values of the detected wireless device. This enables a solution to perform the configuration process (i.e. associating the wireless devices with correct floor information) accurately, quickly and efficiently using a device of the elevator car.

In an embodiment, the data associated with the wireless signal strength values of the detected wireless device comprises a timestamp associated with the maximum signal strength value of the wireless signal strength values. This enables an efficient and simple solution as the elevator controller uses only the timestamp to associate the detected wireless device with a correct landing floor.

In an embodiment, additionally or alternatively, the data associated with the wireless signal strength values of the detected wireless device comprises a set of wireless signal strength value and timestamp pairs. This enables an efficient and simple solution as the elevator car mounted wireless device needs to forward the wireless signal strength value and timestamp pairs to the elevator controller without analyzing them.

In an embodiment, additionally or alternatively, the data associated with the wireless signal strength values of the detected wireless device comprises wireless signal strength values recorded for the detected wireless device and floor information associated with the recorded wireless signal strength values. This enables a solution to perform the configuration process (i.e. associating the wireless devices with correct floor information) accurately, quickly and efficiently.

In an embodiment, additionally or alternatively, the elevator car mounted wireless device comprises a car operating panel.

According to a third aspect of the invention, there is provided an elevator controller for configuring wireless devices in an elevator system. The elevator controller comprises at least one processing unit and at least one memory, wherein the at least one memory stores program instructions that, when executed by the at least one processing unit, cause the elevator controller to: cause an elevator car to perform a travel in an elevator shaft; cause recording of wireless signal strength values based on wireless signals from an elevator car mounted wireless device with a plurality of wireless devices at a plurality of landing floors during the travel; receive from the plurality of wireless devices data associated with the recorded wireless signal strength values; and associate each wireless device with a specific landing floor based on the data received from the wireless devices. This enables a solution to perform the configuration process (i.e. associating the wireless devices with correct floor information) accurately, quickly and efficiently.

In an embodiment, the at least one memory stores program instructions that, when executed by the at least one processing unit, cause the elevator controller to cause the elevator car to stop at locations corresponding to at least some of the landing floors during the travel. By stopping at locations corresponding to at least some of the landing floors during the travel may improve the accuracy of detecting signals from the wireless devices.

In an embodiment, additionally or alternatively, the at least one memory stores program instructions that, when executed by the at least one processing unit, cause the elevator controller to cause the elevator car to open at least one door at each stop. Opening a door or doors may improve the accuracy of detecting signals from the wireless devices.

In an embodiment, additionally or alternatively, the at least one memory stores program instructions that, when executed by the at least one processing unit, cause the elevator controller to cause the elevator car to open its doors at a first side of the elevator car; cause the elevator car to close its doors at the first side; cause the elevator car to open its doors at a second side of the elevator car; and cause the elevator car to close its doors at the second side. Opening a door or doors may improve the accuracy of detecting signals from the wireless devices.

In an embodiment, additionally or alternatively, the data associated with the recorded wireless signal strength values comprises a timestamp associated with the maximum signal strength value of the wireless signal strength values, and wherein the at least one memory stores program instructions that, when executed by the at least one processing unit, cause the elevator controller to determine the location of the elevator car in the elevator shaft based on the timestamp; and associate the wireless device with a landing floor corresponding to the location of the elevator car. This enables an efficient and simple solution as the elevator controller uses only the timestamp to associate the detected wireless device with a correct landing floor.

In an embodiment, additionally or alternatively, the data associated with the recorded wireless signal strength comprises a set of wireless signal strength value and timestamp pairs, and wherein the at least one memory stores program instructions that, when executed by the at least one processing unit, cause the elevator controller to determine the maximum wireless signal strength value based on the wireless signal strength values; determine the location of the elevator car in the elevator shaft based on the timestamp corresponding to the maximum wireless signal strength value; and associate the wireless device with a landing floor corresponding to the location of the elevator car. This enables an efficient and simple solution as the elevator car mounted wireless device needs to forward the wireless signal strength value and timestamp pairs to the elevator controller without analyzing them.

In an embodiment, additionally or alternatively, the elevator car mounted wireless device comprises a car operating panel.

In an embodiment, additionally or alternatively, the wireless devices comprise at least one of landing call station, a hall lantern indicator and a display.

According to a fourth aspect of the invention, there is provided an elevator car mounted wireless apparatus of an elevator system. The elevator car mounted wireless apparatus comprises at least one processing unit and at least one memory, wherein the at least one memory stores program instructions that, when executed by the at least one processing unit, cause the apparatus to record data comprising wireless signal strength values and a device identifier based on wireless signals associated with each detected wireless device at landing floors during a travel of the elevator car in an elevator shaft; associate timestamps for the recorded wireless signal strength values; determine, for each detected wireless device, the maximum wireless signal strength value of the wireless signal strength values; determine the location of the elevator car in the elevator shaft based on the timestamp associated with the maximum wireless signal strength value; and associate the detected wireless device with a landing floor corresponding to the location of the elevator car. This enables a solution to perform the configuration process (i.e. associating the wireless devices with correct floor information) accurately, quickly and efficiently.

In an embodiment, the elevator car mounted wireless device comprises a car operating panel.

According to a fifth aspect of the invention, there is provided a landing floor apparatus. The landing floor apparatus comprises at least one processing unit and at least one memory, wherein the at least one memory stores program instructions that, when executed by the at least one processing unit, cause the apparatus to receive, from an elevator controller, an instruction to record wireless signals transmitted from an elevator car mounted wireless device; record wireless signal strength values of wireless signals received from the elevator car mounted wireless device; associate timestamps for the recorded wireless signal strength values; send data associated with the wireless signal strength values and the timestamps to the elevator controller; and in response to sending the data, receive from the elevator controller configuration data that associates the landing floor apparatus to a specific floor. This enables a solution to perform the configuration process (i.e. associating the wireless devices with correct floor information) accurately, quickly and efficiently.

In an embodiment, the data associated with the wireless signal strength values and the timestamps comprises a timestamp associated with the maximum wireless signal strength value of the wireless signal strength values. This enables an efficient and simple solution as the elevator controller uses only the timestamp to associate the detected wireless device with a correct landing floor.

In an embodiment, additionally or alternatively, the data associated with the wireless signal strength values and the timestamps comprises a set of wireless signal strength value and timestamp pairs. This enables an efficient and simple solution as the wireless devices need to forward the wireless signal strength value and timestamp pairs to the elevator controller without analyzing them.

According to a sixth aspect of the invention, there is provided an elevator system comprising an elevator car configured to move in an elevator shaft; an elevator car mounted wireless device; a plurality of wireless devices at a plurality of landing floors; an elevator controller of the first aspect, and an elevator car mounted wireless apparatus of the second aspect.

According to a seventh aspect of the invention, there is provided an elevator system comprising an elevator car configured to move in an elevator shaft; an elevator car mounted wireless device; a plurality of wireless devices at a plurality of landing floors; an elevator controller of any the third aspect, and a plurality of landing floor apparatuses of the fifth aspect.

According to an eight aspect of the invention, there is provided an elevator system comprising an elevator car configured to move in an elevator shaft; an elevator car mounted wireless device of the fourth aspect; a plurality of wireless devices at a plurality of landing floors and an elevator controller of the third aspect.

According to a ninth aspect of the invention, there is provided a method for configuring wireless devices in an elevator system. The method comprises causing an elevator car to perform a travel in an elevator shaft; causing recording of wireless signal strength values and a device identifier associated with each detected wireless device based on wireless signals from the wireless devices at landing floors with an elevator car mounted wireless device during the travel; receiving data from the elevator car mounted wireless device, the data comprising for each detected wireless device the device identifier of the detected wireless device and data associated with the wireless signal strength values of the detected wireless device; and associating each detected wireless device at the landing floors with a specific landing floor based on the data received from the elevator car mounted wireless device. This enables a solution to perform the configuration process (i.e. associating the wireless devices with correct floor information) accurately, quickly and efficiently.

According to a tenth aspect of the invention, there is provided a method for configuring wireless devices in an elevator system. The method comprises receiving, from an elevator controller, an instruction to record wireless signals transmitted from the wireless devices at landing floors; recording wireless signal strength values and a device identifier associated with each detected wireless device based on wireless signals from the wireless devices during a travel of the elevator car in an elevator shaft; and transmitting data to an elevator controller, the data comprising for each detected wireless device the device identifier of the detected wireless device and data associated with the wireless signal strength values of the detected wireless device. This enables a solution to perform the configuration process (i.e. associating the wireless devices with correct floor information) accurately, quickly and efficiently using a device of the elevator car.

According to an eleventh aspect of the invention, there is provided a method for configuring wireless devices in an elevator system. The method comprises causing an elevator car to perform a travel in an elevator shaft; causing recording of wireless signal strength values based on wireless signals from an elevator car mounted wireless device with a plurality of wireless devices at a plurality of landing floors during the travel; receiving from the plurality of wireless devices data associated with the recorded wireless signal strength values; and associating each wireless device with a specific landing floor based on the data received from the wireless devices. This enables a solution to perform the configuration process (i.e. associating the wireless devices with correct floor information) accurately, quickly and efficiently.

According to a twelfth aspect of the invention, there is provided a method for configuring wireless devices in an elevator system. The method comprises recording data comprising wireless signal strength values and a device identifier based on wireless signals associated with each detected wireless device at landing floors during a travel of an elevator car in an elevator shaft; associating timestamps for the recorded wireless signal strength values; determining, for each detected wireless device, the maximum wireless signal strength value of the wireless signal strength values; determining the location of the elevator car in the elevator shaft based on the timestamp associated with the maximum wireless signal strength value; and associating the detected wireless device with a landing floor corresponding to the location of the elevator car. This enables a solution to perform the configuration process (i.e. associating the wireless devices with correct floor information) accurately, quickly and efficiently.

According to a thirteenth aspect of the invention, there is provided a method for configuring wireless devices in an elevator system. The method comprises receiving, with a wireless device from an elevator controller, an instruction to record wireless signals transmitted from an elevator car mounted wireless device; recording wireless signal strength values of wireless signals received from the elevator car mounted wireless device; associating timestamps for the recorded wireless signal strength values; sending data associated with the wireless signal strength values and the timestamps to the elevator controller; and in response to sending the data, receiving from the elevator controller configuration data that associates the wireless device to a specific floor. This enables a solution to perform the configuration process (i.e. associating the wireless devices with correct floor information) accurately, quickly and efficiently.

According to a fourteenth aspect of the invention, there is provided a computer program comprising program code, which when executed by at least one processing unit, causes the at least one processing unit to perform the method of any of the ninth, tenth, eleventh, twelfth and thirteenth aspect.

In an embodiment, the computer program is embodied on a computer readable medium.

The above discussed means may be implemented, for example, using at least one processor, at least one processor and at least one memory connected to the at least one processor, or at least one processor, at least one memory connected to the at least one processor and an input/output interface connected to the at least one processor.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1A illustrates an elevator system according to a first aspect.

FIG. 1B illustrates an example situation in the elevator system according to the first aspect.

FIG. 1C illustrates an example situation in the elevator system according to the first aspect

FIG. 1D illustrates an elevator system according to a second aspect.

FIG. 1E illustrates an example situation in the elevator system according to the second aspect.

FIG. 1F illustrates an elevator system according to a third aspect.

FIG. 1G discloses a graph illustrating signal strength as a function of time.

FIG. 2 illustrates elements in an elevator system according to an aspect.

FIG. 3A illustrates a block diagram of a controller 200 of an elevator system according to an aspect.

FIG. 3B illustrates a block diagram of a wireless device 316 according to an aspect.

FIG. 4 illustrates a flow diagram of a method for configuring wireless devices in an elevator system according to an aspect.

FIG. 5 illustrates a flow diagram of a method for configuring wireless devices in an elevator system according to an aspect.

FIG. 6 illustrates a flow diagram of a method for configuring wireless devices in an elevator system according to an aspect.

FIG. 7 illustrates a flow diagram of a method for configuring wireless devices in an elevator system according to an aspect.

FIG. 8 illustrates a flow diagram of a method for configuring wireless devices in an elevator system according to an aspect.

### DETAILED DESCRIPTION

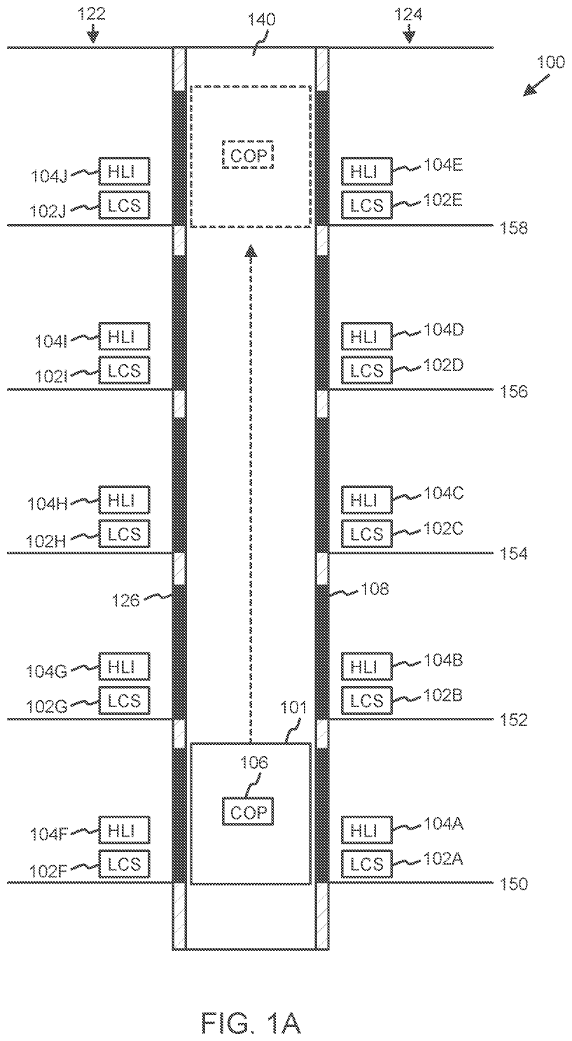

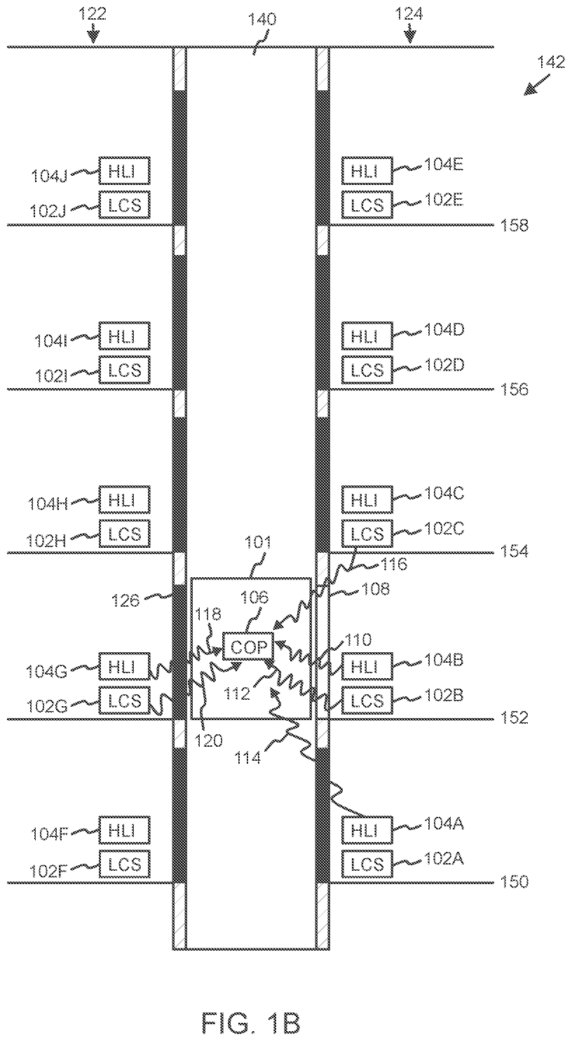

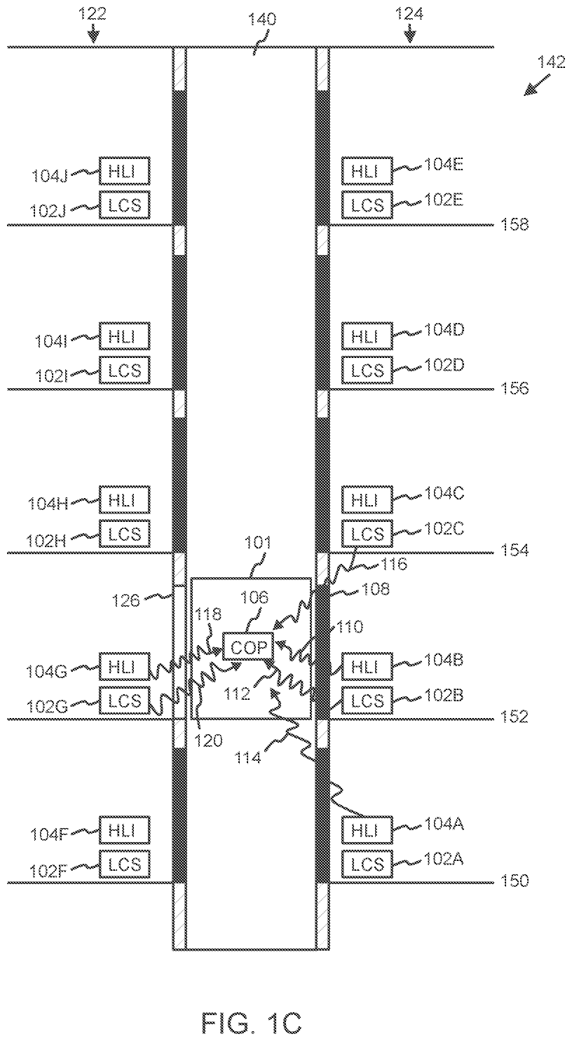

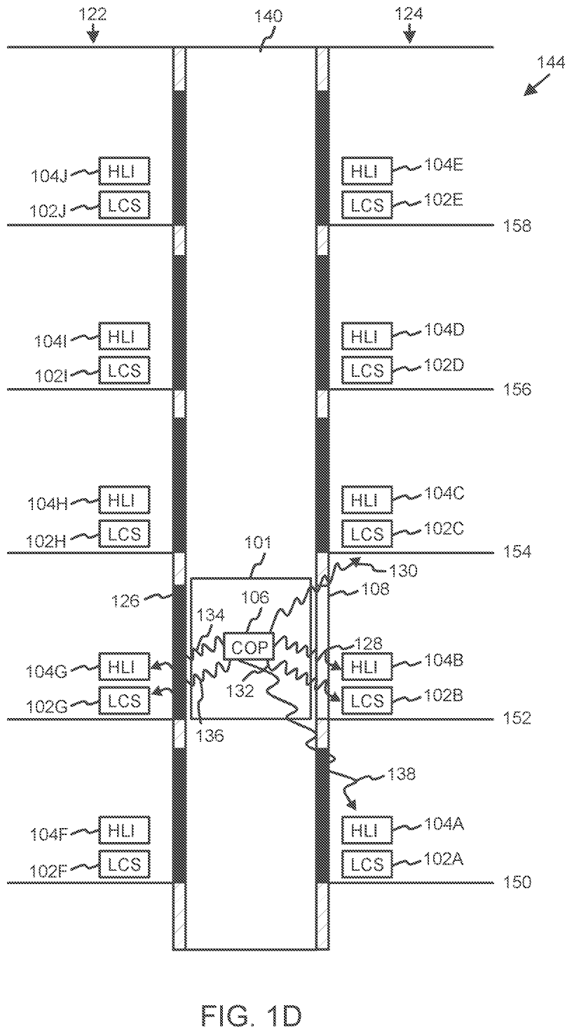

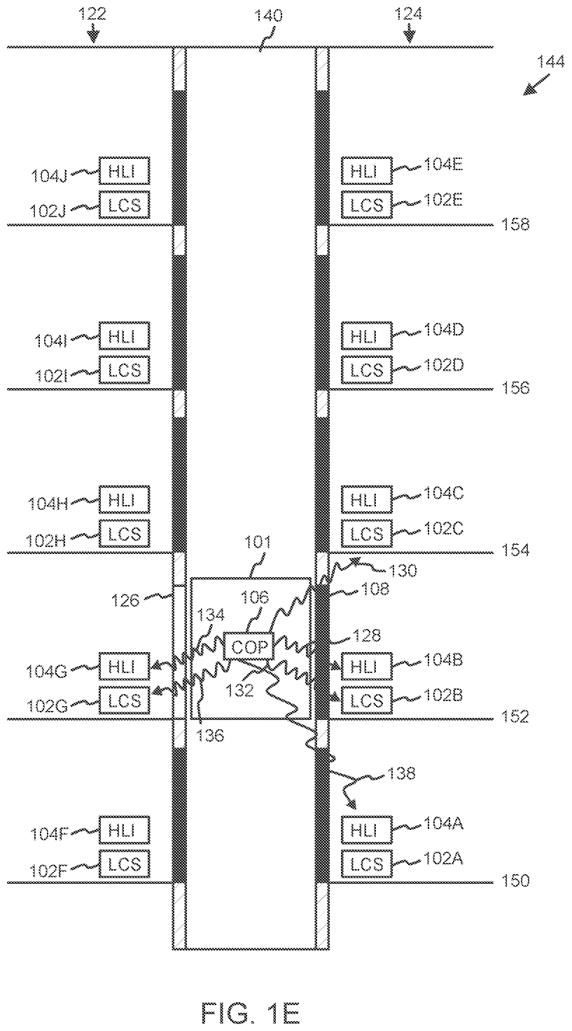

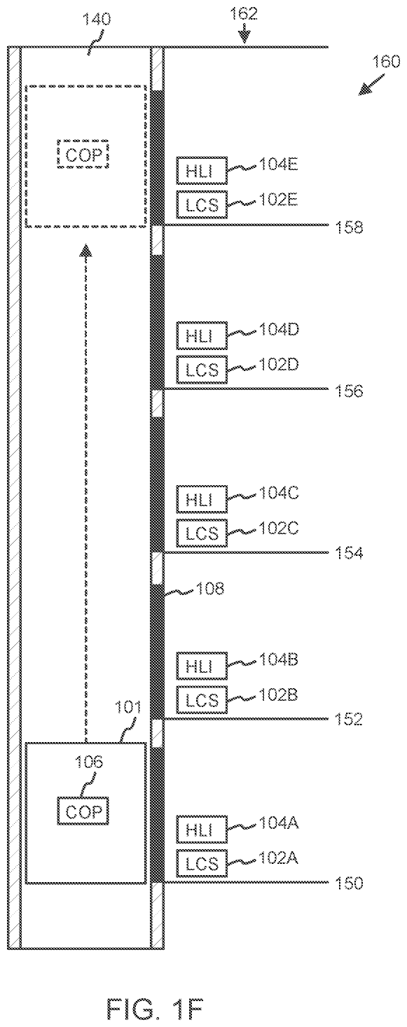

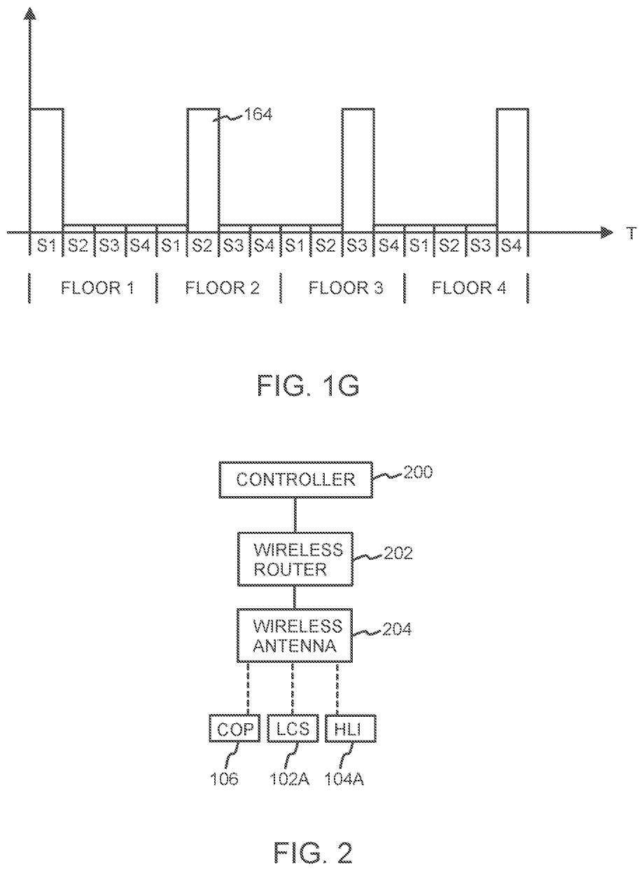

FIG. 1A illustrates an elevator system 100 according to a first aspect. The elevator system comprises an elevator shaft 140 in which an elevator car 101 moves to serve different floors. Although FIG. 1A illustrates five floors 150, 152, 154, 156, 158, it is evident that there may be any number of floors. Similarly, although FIG. 1A illustrates only one elevator shaft 140, there may be more than one elevator shaft in the elevator system. In the elevator system 100 illustrated in FIG. 1A, there are two sides 122, 124 towards which landing doors 108, 126 at each floor can be opened. Although FIG. 1A illustrates two sides 122, 124, in another embodiment it is possible that the elevator car 101 has doors towards more than two sides of the elevator car 101.

The elevator car 101 includes at least one elevator car mounted wireless device 106. The term “wireless device” used herein refers to a device that is able to receive or receive and transmit wireless signals, for example, from a controller (for example, an elevator controller or an elevator group controller of the elevator system). In one embodiment, the elevator car mounted wireless device 106 comprises a car operating panel (COP). It is evident that the elevator car mounted wireless device 106 may refer to any device in the elevator car 101 configured with wireless transmission/reception capabilities.

Each side 122, 124 at each floor 150, 152, 154, 156, 158 includes at least one wireless device 102A-102J, 104A-104J. FIG. 1A illustrates an example where the first wireless device 102A-102J may be a landing call station (LCS) and the second wireless device 104A-104J may be a hall lantern indicator (HLI). In other examples, a display or displays or any other appropriate wireless device needed at a floor may be arranged at all or only some of the floors.

When performing a configuration of the wireless devices 102A-102J, 104A-104J, the elevator car 101 is configured to perform a travel in the elevator shaft 140. The term “travel” may refer to a process where the elevator car 101 may be configured to move in the elevator shaft 140 so that each floor is passed or visited at least once, i.e. the elevator car 101 performs an end-to-end travel. In another embodiment, the travel in the elevator shaft 140 may not be a complete end-to-end travel. For example, it is possible not to travel to one or more of the floors, for example, to the uppermost or the lowermost floor.

FIGS. 1B and 1C illustrate example situations of an elevator system 142 in which the elevator car 101 is configured to stop at locations corresponding to at least some of the floors 150, 152, 154, 156, 158 and additionally is configured to open its side doors one by one. The stopping point may not be the exact location of the elevator car at which it would normally stop when carrying passengers.

FIG. 1B illustrates a situation when the side door towards the side 124 has been opened. In addition to the side door of the elevator car 101, the landing door 108 may be opened simultaneously. When the side door is open, the elevator car mounted wireless device 106 receives wireless signals from multiple sources, i.e. from multiple wireless devices. FIG. 1B illustrates as an example that wireless signals 110, 112, 114, 118, 120 from wireless devices 102B, 102C, 102G, 104A, 104B, 104G are received at the elevator car mounted wireless device 106. Each of the wireless devices wireless devices 102B, 102C, 102G, 104A, 104B, 104G transmit their own device identifiers within their wireless signals. Due to signal attenuation, the wireless signals attenuate when travelling through an obstacle, such as a closed door (elevator car and/or landing doors) or a floor/ceiling of the elevator car or a building. This leads to a situation in which the signal strength of the wireless signals received at the elevator car mounted wireless device 106 varies.

FIG. 1C illustrates a similar setup than in FIG. 1B with the exception that now the side door towards the side 122 has been opened. In addition to the side door of the elevator car 101, the landing door 126 may be opened simultaneously.

In an embodiment, the side doors of the elevator car 101 are not opened simultaneously. In order to improve separation of the wireless signals, the side door at the side 124 may be opened and closed first, and only then the same is repeated for the side door at the other side 122. The opening/closing process of the doors is repeated at each floor where the elevator car 101 stops. Thus, at each floor the elevator car mounted wireless device 106 records the wireless signal strength of the detected wireless devices 102B, 102C, 102G, 104A, 104B, 104G with their identifiers.

As an example, the elevator car mounted wireless device 106 may record for each detected wireless device at each floor, information that “wireless signal strength for wireless device X at floor Y with side Z side door open was N dBm” or “wireless signal strength for wireless device X at floor Y was N dBm”. In another embodiment, the elevator car mounted wireless device 106 records, for each detected wireless device, the wireless signal strength, the device identifier and timestamp indicating the time when the wireless signal strength was recorded. In one embodiment, the wireless signal measurement performed with the elevator car mounted wireless device 106 is triggered when the door of the elevator car 101 has been opened.

In one embodiment, if the wireless signal strength of a specific wireless device is higher/stronger at a subsequent stop at the next floor than during the stop at the previous floor, the information relating to the wireless device may be updated at the elevator car mounted wireless device 106 in accordance with the information relating to the next floor. In another embodiment, the elevator car mounted wireless device 106 separately records information entries at each stop and for each open side door for each detected wireless device. This means that the elevator car mounted wireless device 106 may record multiple (separate) entries for a single detected wireless device.

The elevator car mounted wireless device 106 may send data comprising, for each detected wireless device, the device identifier of the detected wireless device and data associated with the wireless signal strength values of the detected wireless device. The elevator car mounted wireless device 106 may send the data to the elevator controller in a single transmission after the travel has been performed. In another embodiment, the data may be sent to the elevator controller after each stop.

The elevator controller then associates each detected wireless device at the landing floors with a specific landing floor based on the data received from the elevator car mounted wireless device. Further, as the elevator controller now knows the mapping between wireless devices 102A-102J, 104A-104J and the landing floors 150, 152, 154, 156, 158, it may transmit the correct configuration information (i.e. the landing floor information) to the wireless devices 102A-102J, 104A-104J. Thus associating may also comprise transmitting the configuration information (i.e. the floor information) to the wireless devices 102A-102J, 104A-104J.

In an embodiment, if the data received from the elevator car mounted wireless device 106 includes a set “maximum wireless signal strength value, device identifier, timestamp”, the elevator controller is able to determine based on the timestamp the location of the elevator car 101 in the elevator shaft 140 and possibly also the doors open at that point of time. If the information received from the elevator car mounted wireless device 106 includes a plurality of “wireless signal strength value, device identifier, timestamp” sets, the elevator controller then may determine the maximum wireless signal strength value, and based on the timestamp associated with the maximum wireless signal strength value, the elevator controller is able to determine the location of the elevator car 101 in the elevator shaft 140 and possibly also the doors open at that point of time. As the location of the elevator car 101 is linked to a specific floor, the elevator controller is able to associate the detected wireless device with a landing floor corresponding to the location of the elevator car 101.

In another embodiment, the elevator car mounted wireless device 106 may send only a single information pair comprising a device identifier and a timestamp for each wireless device to the elevator controller. The timestamp refers to a time when the wireless signal strength relating to a wireless device reached its maximum value. As the elevator controller knows the location of the elevator car 101 at all times, the elevator controller is able to determine, based on the received timestamp, the location of the elevator car 101 in the elevator shaft 140 and possibly also the doors open at that point of time. As the location of the elevator car 101 is linked to a specific floor, the elevator controller is able to associate the detected wireless device with a landing floor corresponding to the location of the elevator car 101.

In another embodiment, the elevator car mounted wireless device 106 may associate some or all wireless signal strength values with floor information. This means that the elevator car mounted wireless device 106 has access to the information what is the current floor of the elevator car 101. If the data received from the elevator car mounted wireless device 106 includes wireless signal strength values recorded for the detected wireless device and also floor information associated with the recorded wireless signal strength values, the elevator controller first determines the maximum wireless signal strength value from the data. Then, the elevator controller associates the wireless devices with a landing floor based on the floor information associated with the maximum wireless signal strength value.

In another embodiment, instead of the elevator controller, the elevator car mounted wireless device 106 may be used to configure the wireless devices 102A-102J, 104A-104J. The elevator car mounted wireless device 106 may record data comprising wireless signal strength values and a device identifier based on wireless signals associated with each detected wireless device 102A-102J, 104A-104J at landing floors 150, 152, 155, 156, 158 during a travel of the elevator car in an elevator shaft 140. The elevator car mounted wireless device 106 may also associate timestamps for the recorded wireless signal strength values. Further, the elevator car mounted wireless device 106 may also determine, for each detected wireless device 102A-102J, 104A-104J, the maximum wireless signal strength value of the wireless signal strength values. The elevator car mounted wireless device 106 may also determine the location of the elevator car 101 in the elevator shaft 140 based on the timestamp associated with the maximum wireless signal strength value. The elevator car mounted wireless device 106 may have knowledge of the location of the elevator car 101 in the elevator shaft 140 at any time during the travel. The elevator car mounted wireless device 106 may also associate the detected wireless device with a landing floor corresponding to the location of the elevator car.

When the elevator car 101 travels in the elevator shaft 140, and when the wireless signal strength reaches its maximum, this may also provide an indication that then the elevator car mounted wireless device 106 is closest to the detected wireless device, thus indicating also the floor information for the detected wireless device. Thus, the elevator controller may be able to determine where each wireless device is located (which floor and which side).

By performing wireless device configurations as illustrated above with reference to FIGS. 1A-1C, the configuration process can be performed accurately, quickly and efficiently.

Yet in another embodiment, the elevator car 101 is caused to perform the travel in the elevator shaft without opening the elevator doors during the travel. The elevator car 101 may also travel in the elevator shaft 140 without stopping at the floors 150, 152, 154, 156, 158 and the elevator car mounted wireless device 106 measures wireless signals when the elevator car 101 moves in the elevator shaft 140. Thus, even in this case, the elevator can mounted wireless device 106 may be able to measure signal strengths from the wireless devices 102A-102J, 104A-104J and enable associating the wireless device with correct landing floors.

In an embodiment, the elevator car 101 may not travel to one or more of the floors, for example, to the uppermost or the lowermost floor. In this case, if the elevator car 101 does not travel to the uppermost floor, the elevator controller is able to allocate the remaining wireless devices to the correct floor (i.e. the uppermost floor) as it knows which floor has not been visited.

FIGS. 1D and 1E illustrate an elevator system 144 according to a second aspect. The example illustrated in FIGS. 1D and 1E differs from the example illustrated in FIGS. 1A, 1B and 10 in that now the elevator car mounted wireless device 106 transmits wireless signals that are received by the wireless devices 102B, 102C, 102G, 104A, 104B, 104G. In other words, the transmission direction of the wireless signals is reversed. It is evident that although it is illustrated here that only the wireless device 102B, 1020, 102G, 104A, 104B, 104G receive the wireless signals from the elevator car mounted wireless device 106, also one or more of the remaining wireless devices may receive the wireless signals sent by the elevator car mounted wireless device 106.

When performing a configuration of the wireless devices 102A-102J, 104A-104J, the elevator car 101 is configured to perform a travel in the elevator shaft 140. The term “travel” may refer to a process where the elevator car 101 is configured to move in the elevator shaft 140 so that each floor is passed or visited at least once, i.e. the elevator car 101 performs an end-to-end travel. In another embodiment, the travel in the elevator shaft 140 may not be a complete end-to-end travel. For example, it is possible not to travel to one or more of the floors, for example, to the uppermost or the lowermost floor. FIGS. 1D and 1E illustrate an embodiment where the elevator car 101 may be configured to stop at each floor 150, 152, 154, 156, 158 and additionally is configured to open its side doors one by one. The phrase “stop at each floor” may mean that the elevator car 101 stops to exact floor position in the elevator shaft 140. The phrase may also mean to include any location in the elevator shaft 140 that differs from the exact floor position but can still be linked to the floor (for example, due to the fact that the elevator car 101 is closer to this floor than to another). In another embodiment, the elevator car 101 may be caused to perform the travel in the elevator shaft without opening the elevator doors during the travel. The elevator car 101 may also travel in the elevator shaft 140 without stopping at the floors 150, 152, 154, 156, 158.

FIG. 1D illustrates the example situation when the side door towards the side 124 has been opened. In addition to the side door of the elevator car 101, the landing door 108 may be opened simultaneously. As illustrated in FIG. 1D, the elevator car 101 opens its doors towards the side 124 and each wireless device 102B, 102C, 102G, 104A, 104B, 104G receives and records wireless signal strength values of wireless signals 128, 132, 134, 136, 138 from the elevator car mounted wireless device 106. The wireless devices 102B, 102C, 102G, 104A, 104B, 104G may also record the time (i.e. provide a timestamp) together with the measured wireless signal strength value when they store information about the received wireless signals. In an embodiment, the wireless devices 102B, 102C, 102G, 104A, 104B, 104G may be configured to perform multiple measurements within a specific time window and to store a signal strength value and a timestamp for each measurement. Further, the elevator car mounted wireless device 101 may be configured to transmit wireless signals only when the elevator doors are open. Due to signal attenuation, the wireless signals attenuate when travelling through an obstacle, such as a closed door (elevator car and/or landing doors) or a floor/ceiling of the elevator car or a building. This leads to a situation in which the signal strength of the wireless signals received by the wireless devices 102B, 102C, 102G, 104A, 104B, 104G varies.

FIG. 1E illustrates a similar setup than in FIG. 1D with the exception that now the side door towards the side 122 has been opened. In addition to the side door of the elevator car 101, the landing door 126 may be opened simultaneously. In an embodiment, the side doors of the elevator car 101 are not opened simultaneously. In order to improve separation of the wireless signals, the side door at the side 124 may be opened and closed first, and only then the same is repeated for the side door at the side 122. The opening/closing process of the doors is repeated at each floor where the elevator car 101 stops. Thus, at each floor the wireless devices 102B, 1020, 102G, 104A, 104B, 104G record wireless signal strength values from the elevator car mounted wireless device 106 together with a timestamp.

Thus, each wireless device 102B, 102C, 102G, 104A, 104B, 104G may record information that “wireless signal strength reached its maximum dBm at time 13:01:59”. In another embodiment, each wireless device 102B, 102C, 102G, 104A, 104B, 104G may store several signal strength and timestamp pairs (i.e. information entries).

In one embodiment, the wireless signal measurement performed the wireless devices 102B, 102C, 102G, 104A, 104B, 104G is triggered when the door of the elevator car 101 has been opened.

The wireless devices 102B, 1020, 102G, 104A, 104B, 104G then send to a controller in the elevator system a time or timestamp when the signal strength from the elevator car mounted wireless device 106 reached its maximum. Alternatively, each wireless device 102B, 102C, 102G, 104A, 104B, 104G may send to the elevator controller several signal strength and timestamp pairs (signal strength value, xx:xx:xx:xx) and the elevator controller then determines the maximum wireless signal strength value from the received information for each wireless device 102B, 102C, 102G, 104A, 104B, 104G.

Based on the received information from the wireless devices 102B, 102C, 102G, 104A, 104B, 104G, the controller is able to associate each wireless device 102B, 102C, 102G, 104A, 104B, 104G with a specific landing floor. In other words, the elevator controller is aware of the location of the elevator car 101 in the elevator shaft 140 at all times. It also knows when the doors of the elevator car 101 or the doors at the landing floors were open. Therefore, the timestamp indicates the location of each wireless device 102B, 102C, 102G, 104A, 104B, 104G (i.e. floor information, or floor and side information) as their location is the same as the location of the elevator car 101 at the time when the signal strength reached the maximum value. Thus associating may also comprise transmitting the configuration information (i.e. the floor information) to the wireless devices 102A-102J, 104A-104J.

By performing the wireless device configuration as discussed above with reference to FIGS. 1D-1E, the configuration process can be performed accurately and quickly.

In an embodiment, in any of the examples disclosed in FIGS. 1A-1C and 1D-1E, the elevator car mounted wireless device 106 and the wireless devices 102A-102J, 104A-104J may operate in a configuration mode. This may mean that during the travel of the elevator care, in the examples of FIGS. 1A-1C, the elevator car mounted wireless device 106 may be configured to detect signals from other wireless device and the wireless devices 102A-102J, 104A-104J may be configured to transmit their identifiers. Similarly, in the examples of FIGS. 1D-1E, it may mean that the elevator car mounted wireless device 106 may be configured to transmit wireless signals and the wireless devices 102A-102J, 104A-104J may be configured to detect wireless signals from the elevator car mounted wireless device 106. Additionally, in another embodiment, the elevator car mounted wireless device 106 and the wireless devices 102A-102J, 104A-104J may be configured to operate in the configuration mode only when the elevator doors are open.

FIG. 1F illustrates an elevator system 160 according to a third aspect. The difference of this aspect compared to the earlier aspects or examples is that the doors of the elevator car 101 open only to a single side 162 of the elevator shaft 140. Therefore, at each stop the elevator doors may be opened only towards the side 162. Taking this difference into account, the example illustrated in FIG. 1F may operate identically than was discussed above relating to examples illustrated in FIGS. 1A-1C and 1D-1E. Therefore, identical content is not repeated here.

In this aspect, the configuration process of the wireless devices 102A-102J, 104A-104J can be made even more efficient so that the elevator car 101 is caused to perform the travel in the elevator shaft 140 without opening the elevator doors during the travel. This means that the elevator car 101 does not stop at the floors 150, 152, 154, 156, 158, and the elevator car mounted wireless device 106 measures wireless signals from the wireless devices 102A-102D, 104A-104D or the wireless devices 102A-102J, 104A-104J measure wireless signals from the elevator car mounted wireless device 106 when the elevator car 101 moves in the elevator shaft 140.

In an embodiment of FIG. 1A-1C or 1F, the wireless devices 102A-102J, 104A-104J at the floors 150, 152, 154, 156, 158 communicate with an elevator controller or an elevator group controller wirelessly. Although the controller does not yet know floor locations of the wireless devices 102A-102J, 104A-104J, it may instruct the wireless devices 102A-102J, 104A-104J to transmit wireless signals one at a time. In other words, each wireless device 102A-102J, 104A-104J has a specific time slot when to transmit and outside this time slot the wireless device 102A-102J, 104A-104J does not transmit any signals. This also means that the controller has associated one device identifier with each time slot. Thus, there are a set of subsequent time slots and only one wireless device 102A-102J, 104A-104J is transmitting at each time slot. The controller may cause the wireless devices 102A-102J, 104A-104J to perform the “slot transmission” during a configuration mode. It is also assumed here that there are four floors in total and there is a single wireless device at each floor.

When the elevator car 101 performs a travel in the elevator shaft 140, the elevator car mounted wireless device 106 then records or is caused to record signals from the wireless devices 102A-102J, 104A-104J as a function of time. During the travel, the elevator car 101 may be caused to stop at each floor 150, 152, 154, 156, 158. Additionally, the elevator car 101 may be caused to open its doors as already disclosed in the examples above. As a result of the travel, the elevator car mounted wireless device 106 has recorded signals from the wireless devices 102A-102J, 104A-104J as a function of time, as illustrated in FIG. 1G. The x-axis has been divided into time slots S1-S4, and during a time slot, only one wireless device 102A-102J, 104A-104J transmits signals, as instructed by the controller.

The controller then receives the wireless signal strength values associated time from the elevator car mounted wireless device 106. As the controller knows when each of the wireless devices 102A-102J, 104A-104J was transmitting, it can deduce the floor at which a wireless device 102A-102J, 104A-104J is located by comparing time of a time slot having its signal maximum to time associated with the location of the elevator car 101 in the elevator shaft 140. As an example, a time slot S2 has its maximum signal strength at 164 and during that time, the elevator car 101 stopped at the second floor. After the comparison, the controller is able to associate each wireless device 102A-102J, 104A-104J to a specific floor (and possibly also to a specific side).

Further, in another embodiment of FIG. 1A-1C or 1F, the wireless devices 102A-102J, 104A-104J at the floors 150, 152, 154, 156, 158 communicate with an elevator controller or an elevator group controller wirelessly. Although the controller may not yet know floor locations of the wireless devices 102A-102J, 104A-104J, it may instruct the wireless devices 102A-102J, 104A-104J to transmit wireless signals in a configuration mode in a specific way. Each wireless device 102A-102J, 104A-104J may be configured to transmit wireless signals using a frequency specific to the wireless device. In other words, each of the wireless devices 102A-102J, 104A-104J transmits at a different frequency. The controller has mapped a specific wireless device to use a specific frequency.

When the elevator car 101 performs a travel in the elevator shaft 140, the elevator car mounted wireless device 106 records or is caused to record signals from the wireless devices 102A-102J, 104A-104J. As illustrated in earlier examples, during the travel, the elevator car 101 may be caused to stop at each floor 150, 152, 154, 156, 158. Additionally, the elevator car 101 may be caused to open its doors as already disclosed in the examples above. As a result of the travel, the elevator car mounted wireless device 106 has recorded signals at different frequencies from the wireless devices 102A-102J, 104A-104J as a function of time.

The controller then receives the recorded signals from the elevator car mounted wireless device 106. As the controller knows the frequencies used by the wireless devices 102A-102J, 104A-104J, it can deduce the floor at which a wireless device 102A-102J, 104A-104J is located by first determining when the signal strength reached a maximum level at a frequency associated with the wireless device 102A-102J, 104A-104J. The time moment at which the maximum level was reached is the compared to time associated with the location of the elevator car 101 in the elevator shaft 140. After the comparison, the controller is able to associate each wireless device 102A-102J, 104A-104J to a specific floor (and possibly also to a specific side).

FIG. 2 illustrates elements in an elevator system according to an aspect. The elevator system comprises a controller 200 connected to at least one wireless router 202. At least one wireless antenna 204 is connected to the at least one wireless router 202. Wireless device illustrated in the examples of FIGS. 1A-1E, i.e. the elevator car mounted wireless device 106 and wireless devices 102A, 104A and the landing floors are wirelessly connected to the at least one wireless antenna 204. Wireless signals between the devices may be transmitted using any appropriate wireless transmission technology, for example, wireless local area network (WLAN) signaling. This is, however, only one example of the available or future wireless transmission technologies.

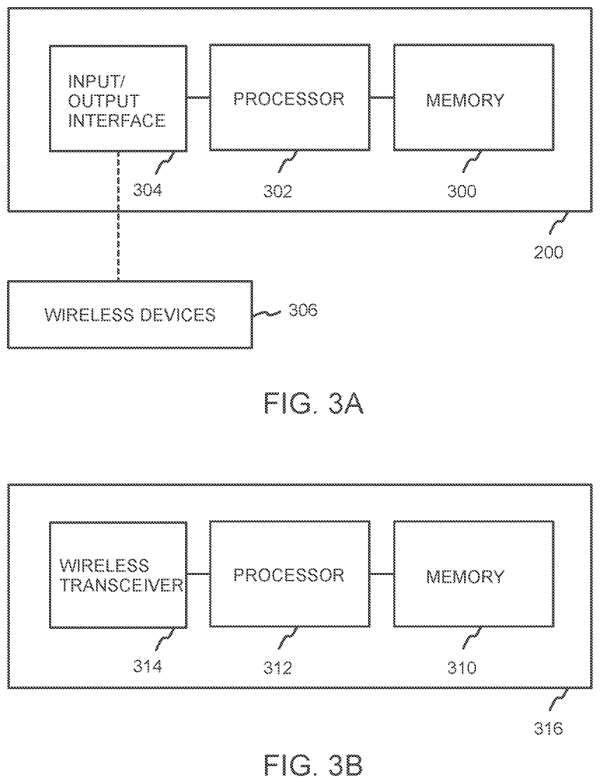

FIG. 3A illustrates a block diagram of a controller 200 of an elevator system according to an aspect. The controller 200 comprises at least one processor 302 connected to at least one memory 300. The at least one memory 300 may comprise at least one computer program which, when executed by the processor 302 or processors, causes the controller 200 to perform the programmed functionality. In another embodiment, the at least one memory 300 may be an internal memory of the at least one processor 302. The controller 200 may also comprise an input/output interface 304. Via the input/output interface 304, the control apparatus may be connected to at least one wireless device 306. The at least one wireless device 306 comprises, for example, the elevator car mounted wireless device 106 and wireless devices 102A-102J, 104A-104J at the landing floors. The illustrated components are not required or all-inclusive, as any components can deleted and other components can be added.

The controller 200 may be a control entity configured to implement only the above disclosed operating features, or it may be part of a larger elevator control entity, for example, an elevator controller or an elevator group controller.

In an embodiment, the at least one memory 300 may store program instructions that, when executed by the at least one processor 302, cause the controller 200 to cause an elevator car to perform a travel in an elevator shaft; cause recording of wireless signal strength values and a device identifier associated with each detected wireless device based on wireless signals from the wireless devices at landing floors with an elevator car mounted wireless device during the travel; receive data from the elevator car mounted wireless device, the data comprising for each detected wireless device the device identifier of the detected wireless device and data associated with the wireless signal strength values of the detected wireless device; and associate each detected wireless device at the landing floors with a specific landing floor based on the data received from the elevator car mounted wireless device.

In another embodiment, the at least one memory 300 may store program instructions that, when executed by the at least one processor 302, cause the controller 200 to cause an elevator car to perform a travel in an elevator shaft; cause recording of wireless signal strength values based on wireless signals from an elevator car mounted wireless device with a plurality of wireless devices at a plurality of landing floors during the travel; receive from the plurality of wireless devices data associated with the recorded wireless signal strength values; and associate each wireless device with a specific landing floor based on the data received from the wireless devices.

In addition to the above, the controller 200 may be configured to perform any of the operations disclosed in the examples of FIGS. 1A-1G.

FIG. 3B illustrates a block diagram of a wireless device 316 according to an aspect. The wireless device 316 comprises, for example, the elevator car mounted wireless device 106. The wireless device 316 comprises at least one processor 312 connected to at least one memory 310. The at least one memory 310 may comprise at least one computer program which, when executed by the processor 312 or processors, causes the wireless device 316 to perform the programmed functionality. In another embodiment, the at least one memory 310 may be an internal memory of the at least one processor 312. The wireless device 316 may also comprise a wireless transceiver 314. Via the wireless transceiver 314, the wireless device 316 may be connected, for example, to a controller of an elevator system. In an embodiment, the wireless device 316 is a car operating panel. The illustrated components are not required or all-inclusive, as any components can deleted and other components can be added.

In an embodiment, the at least one memory 310 stores program instructions that, when executed by the at least one processor 312, cause the elevator car mounted wireless device 106 to receive, from an elevator controller, an instruction to record wireless signals transmitted from the wireless devices at landing floors; record wireless signal strength values and a device identifier associated with each detected wireless device based on wireless signals from the wireless devices during a travel of the elevator car in an elevator shaft; and transmit data to an elevator controller, the data comprising for each detected wireless device the device identifier of the detected wireless device and data associated with the wireless signal strength values of the detected wireless device.

In another embodiment, the at least one memory 310 may store program instructions that, when executed by the at least one processor 312, cause the elevator car mounted wireless device 106 to record data comprising wireless signal strength values and a device identifier based on wireless signals associated with each detected wireless device at landing floors during a travel of the elevator car in an elevator shaft; associate timestamps for the recorded wireless signal strength values; determine, for each detected wireless device, the maximum wireless signal strength value of the wireless signal strength values; determine the location of the elevator car in the elevator shaft based on the timestamp associated with the maximum wireless signal strength value; and associate the detected wireless device with a landing floor corresponding to the location of the elevator car.

In another embodiment, the wireless device 316 may comprise a wireless device at a landing floor. The at least one memory 310 may store program instructions that, when executed by the at least one processor, cause the wireless device 316 to receive, from an elevator controller, an instruction to record wireless signals transmitted from an elevator car mounted wireless device; record wireless signal strength values of wireless signals received from the elevator car mounted wireless device; associate timestamps for the recorded wireless signal strength values; send data associated with the wireless signal strength values and the timestamps to the elevator controller; and in response to sending the data, receive from the elevator controller configuration data that associates the landing floor apparatus to a specific floor.

In addition to the above, the wireless device 316 may be configured to perform any of the operations disclosed in the examples of FIGS. 1A-1G.

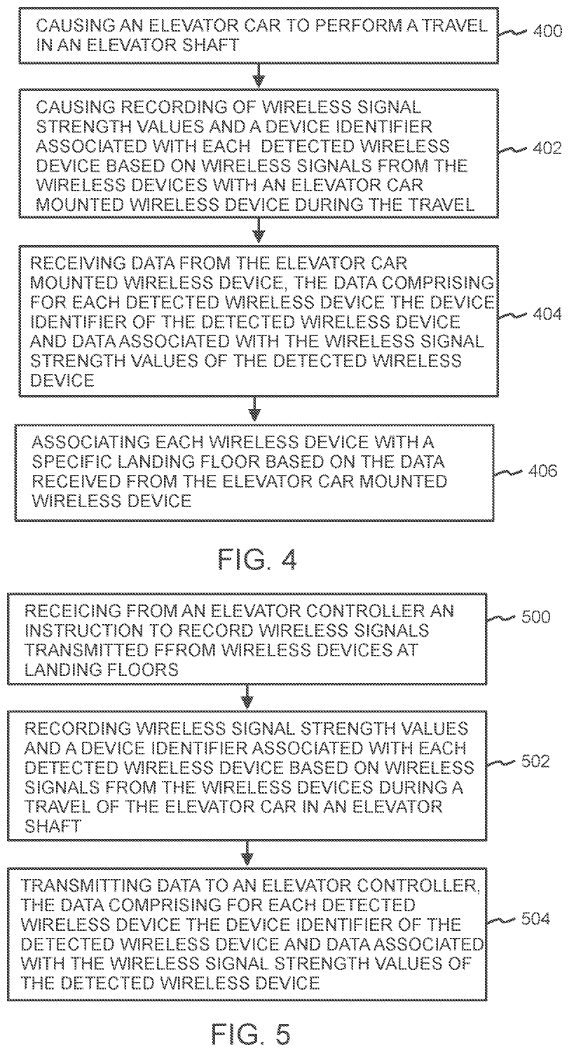

FIG. 4 illustrates a flow diagram of a method for configuring wireless devices in an elevator system according to an aspect. The method may be performed by an apparatus of an elevator system, for example, an elevator controller.

At 400, the method comprises causing an elevator car to perform a travel in an elevator shaft.

At 402, the method comprises causing recording of wireless signal strength values and a device identifier associated with each detected wireless device based on wireless signals from the wireless devices at landing floors with an elevator car mounted wireless device during the travel.

At 404, the method comprises receiving data from the elevator car mounted wireless device, the data comprising for each detected wireless device the device identifier of the detected wireless device and data associated with the wireless signal strength values of the detected wireless device.

At 406, the method comprises associating each detected wireless device at the landing floors with a specific landing floor based on the data received from the elevator car mounted wireless device.

FIG. 5 illustrates a flow diagram of a method for configuring wireless devices in an elevator system according to an aspect. The method may be performed by an apparatus of an elevator system, for example, an elevator car mounted wireless device.

At 500, the method comprises receiving, from an elevator controller, an instruction to record wireless signals transmitted from wireless devices at landing floors.

At 502, the method comprises recording wireless signal strength values and a device identifier associated with each detected wireless device based on wireless signals from the wireless devices during a travel of the elevator car in an elevator shaft.

At 504, the method comprises transmitting data to an elevator controller, the data comprising for each detected wireless device the device identifier of the detected wireless device and data associated with the wireless signal strength values of the detected wireless device

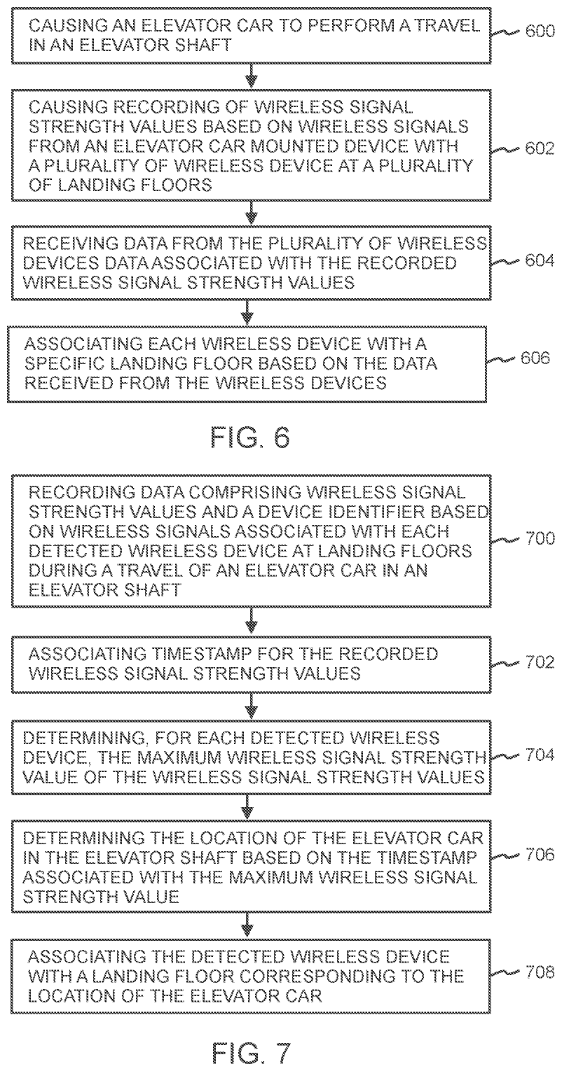

FIG. 6 illustrates a flow diagram of a method for configuring wireless devices in an elevator system according to an aspect. The method may be performed by an apparatus of an elevator system, for example, an elevator controller.

At 600 the method comprises causing an elevator car to perform a travel in an elevator shaft.

At 602 the method comprises causing recording of wireless signal strength values based on wireless signals from an elevator car mounted wireless device with a plurality of wireless devices at a plurality of landing floors during the travel.

At 604 the method comprises receiving from the plurality of wireless devices data associated with the recorded wireless signal strength values.

At 606 the method comprises associating each wireless device with a specific landing floor based on the data received from the wireless devices.

FIG. 7 illustrates a flow diagram of a method for configuring wireless devices in an elevator system according to an aspect. The method may be performed by an apparatus of an elevator system, for example, an elevator car mounted wireless device.

At 700 the method comprises recording data comprising wireless signal strength values and a device identifier based on wireless signals associated with each detected wireless device at landing floors during a travel of an elevator car in an elevator shaft.

At 702 the method comprises associating timestamps for the recorded wireless signal strength values.

At 704 the method comprises determining, for each detected wireless device, the maximum wireless signal strength value of the wireless signal strength values.

At 706 the method comprises determining the location of the elevator car in the elevator shaft based on the timestamp associated with the maximum wireless signal strength value.

At 708 the method comprises associating the detected wireless device with a landing floor corresponding to the location of the elevator car.

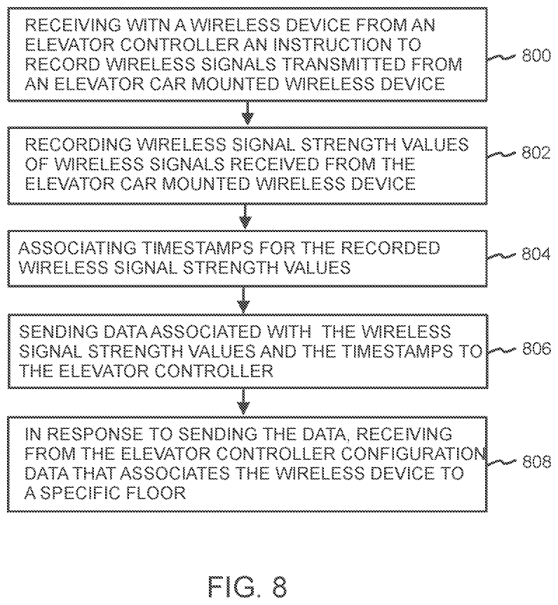

FIG. 8 illustrates a flow diagram of a method for configuring wireless devices in an elevator system according to an aspect. The method may be performed by an apparatus of an elevator system, for example, a wireless device located at any floor in a building comprising the elevator system.

At 800 the method comprises receiving, with a wireless device from an elevator controller, an instruction to record wireless signals transmitted from an elevator car mounted wireless device.

At 802 the method comprises recording wireless signal strength values of wireless signals received from the elevator car mounted wireless device.

At 804 the method comprises associating timestamps for the recorded wireless signal strength values.

At 806 the method comprises sending data associated with the wireless signal strength values and the timestamps to the elevator controller.

At 808 the method comprises, in response to sending the data, receiving from the elevator controller configuration data that associates the wireless device to a specific floor.

The exemplary embodiments and aspects of the invention can be included within any suitable device, for example, including, servers, workstations, capable of performing the processes of the exemplary embodiments. The exemplary embodiments may also store information relating to various processes described herein.

Example embodiments may be implemented in software, hardware, application logic or a combination of software, hardware and application logic. The example embodiments can store information relating to various methods described herein. This information can be stored in one or more memories, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

All or a portion of the example embodiments can be conveniently implemented using one or more general purpose processors, microprocessors, digital signal processors, micro-controllers, and the like, programmed according to the teachings of the example embodiments, as will be appreciated by those skilled in the computer and/or software art(s). Appropriate software can be readily prepared by programmers of ordinary skill based on the teachings of the example embodiments, as will be appreciated by those skilled in the software art. In addition, the example embodiments can be implemented by the preparation of application-specific integrated circuits or by interconnecting an appropriate network of conventional component circuits, as will be appreciated by those skilled in the electrical art(s). Thus, the examples are not limited to any specific combination of hardware and/or software. Stored on any one or on a combination of computer readable media, the examples can include software for controlling the components of the example embodiments, for driving the components of the example embodiments, for enabling the components of the example embodiments to interact with a human user, and the like. Such computer readable media further can include a computer program for performing all or a portion (if processing is distributed) of the processing performed in implementing the example embodiments. Computer code devices of the examples may include any suitable interpretable or executable code mechanism, including but not limited to scripts, interpretable programs, dynamic link libraries (DLLs), Java classes and applets, complete executable programs, and the like.

As stated above, the components of the example embodiments may include computer readable medium or memories for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed foam or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. An elevator controller of an elevator system, the elevator controller comprising:
at least one processing unit;
at least one memory;
wherein the at least one memory stores program instructions that, when executed by the at least one processing unit, cause the elevator controller to:
cause an elevator car to perform a travel in an elevator shaft;
cause recording of wireless signal strength values and a device identifier associated with each detected wireless device based on wireless signals from the wireless devices at landing floors with an elevator car mounted wireless device during the travel;
receive data from the elevator car mounted wireless device, the data comprising for each detected wireless device the device identifier of the detected wireless device and data associated with the wireless signal strength values of the detected wireless device; and
associate each detected wireless device at the landing floors with a specific landing floor based on the data received from the elevator car mounted wireless device.

2. An elevator controller according to claim 1, wherein the at least one memory stores program instructions that, when executed by the at least one processing unit, cause the elevator controller to:
cause the elevator car to stop at locations corresponding to at least some of the landing floors during the travel.

3. An elevator controller according to claim 2, wherein the at least one memory stores program instructions that, when executed by the at least one processing unit, cause the elevator controller to:
cause the elevator car to open at least one door at each stop.

4. An elevator controller according to claim 3, wherein the at least one memory stores program instructions that, when executed by the at least one processing unit, cause the elevator controller to:
cause the elevator car to open its doors at a first side of the elevator car;
cause the recording of the wireless signals at a time when the doors are open at the first side;
cause the elevator car to close its doors at the first side;
cause the elevator car to open its doors at a second side of the elevator car;
cause the recording of the wireless signals at a time when the doors are open at the second side;
cause the elevator car to close its doors at the second side.

5. An elevator controller according to claim 1, wherein the at least one memory stores program instructions that, when executed by the at least one processing unit, cause the elevator controller to:
cause the elevator car to perform the travel in the elevator shaft without opening elevator doors during the travel.

6. An apparatus according to claim 1, wherein the data associated with the wireless signal strength values of the detected wireless device comprises a timestamp associated with the maximum signal strength value of the wireless signal strength values, and wherein the at least one memory stores program instructions that, when executed by the at least one processing unit, cause the elevator controller to:
determine the location of the elevator car in the elevator shaft based on the timestamp; and
associate the detected wireless device with a landing floor corresponding to the location of the elevator car.

7. An elevator controller according to claim 1, wherein the data associated with the wireless signal strength values of the detected wireless device comprises a set of wireless signal strength value and timestamp pairs, and wherein the at least one memory stores program instructions that, when executed by the at least one processing unit, cause the elevator controller to:
determine the maximum wireless signal strength value based on the wireless signal strength values;
determine the location of the elevator car in the elevator shaft based on the timestamp corresponding to the maximum wireless signal strength value; and
associate the detected wireless device with a landing floor corresponding to the location of the elevator car.

8. An elevator controller according to claim 1, wherein the data associated with the wireless signal strength values of the detected wireless device comprises wireless signal strength values recorded for the detected wireless device and floor information associated with the recorded wireless signal strength values, and wherein the at least one memory stores program instructions that, when executed by the at least one processing unit, cause the elevator controller to:
determine the maximum wireless signal strength value based on the wireless signal strength values; and
associate the detected wireless device with a landing floor based on the floor information associated with the maximum wireless signal strength value.

9. An elevator controller according to claim 1, wherein the at least one memory stores program instructions that, when executed by the at least one processing unit, cause the elevator controller to:
cause the wireless devices to operate in a configuration mode during the travel, wherein in the configuration mode a device identifier associated with each wireless device is transmitted.

10. An elevator controller according to claim 1, wherein the elevator car mounted wireless device comprises a car operating panel.

11. An elevator controller according to claim 1, wherein the wireless devices comprise at least one of a landing call station, a hall lantern indicator and a display.

12. An elevator controller according to claim 1, wherein the at least one memory stores program instructions that, when executed by the at least one processing unit, cause the apparatus to configure the wireless devices to use a specific time slot or frequency in transmitting wireless signals.

13. An elevator car mounted apparatus comprising:
at least one processing unit;
at least one memory;
wherein the at least one memory stores program instructions that, when executed by the at least one processing unit, cause the apparatus to:
receive, from an elevator controller, an instruction to record wireless signals transmitted from wireless devices at landing floors;
record wireless signal strength values and a device identifier associated with each detected wireless device based on wireless signals from the wireless devices during a travel of the elevator car in an elevator shaft; and
transmit data to an elevator controller, the data comprising for each detected wireless device the device identifier of the detected wireless device and data associated with the wireless signal strength values of the detected wireless device.

14. An elevator car mounted apparatus according to claim 13, wherein the data associated with the wireless signal strength values of the detected wireless device comprises a timestamp associated with the maximum signal strength value of the wireless signal strength values.

15. An elevator car mounted apparatus according to claim 13, wherein the data associated with the wireless signal strength values of the detected wireless device comprises a set of wireless signal strength value and timestamp pairs.

16. An elevator car mounted apparatus according to claim 13, wherein the data associated with the wireless signal strength values of the detected wireless device comprises wireless signal strength values recorded for the detected wireless device and floor information associated with the recorded wireless signal strength values.

17. An elevator car mounted apparatus according to claim 13, wherein the elevator car mounted wireless device comprises a car operating panel.

18. An elevator controller for configuring wireless devices in an elevator system, the elevator controller comprising:
at least one processing unit;
at least one memory;
wherein the at least one memory stores program instructions that, when executed by the at least one processing unit, cause the elevator controller to:
cause an elevator car to perform a travel in an elevator shaft;
cause recording of wireless signal strength values based on wireless signals from an elevator car mounted wireless device with a plurality of wireless devices at a plurality of landing floors during the travel;
receive from the plurality of wireless devices data associated with the recorded wireless signal strength values; and
associate each wireless device with a specific landing floor based on the data received from the wireless devices.

19. An elevator controller according to claim 18, wherein the at least one memory stores program instructions that, when executed by the at least one processing unit, cause the elevator controller to:
cause the elevator car to stop at locations corresponding to at least some of the landing floors during the travel.

20. An elevator controller according to claim 19, wherein the at least one memory stores program instructions that, when executed by the at least one processing unit, cause the elevator controller to:
cause the elevator car to open at least one door at each stop.

21. An elevator controller according to claim 20, wherein the at least one memory stores program instructions that, when executed by the at least one processing unit, cause the elevator controller to:
cause the elevator car to open its doors at a first side of the elevator car;
cause the elevator car to close its doors at the first side;
cause the elevator car to open its doors at a second side of the elevator car; and
cause the elevator car to close its doors at the second side.

22. An elevator controller according to claim 18, wherein the data associated with the recorded wireless signal strength values comprises a timestamp associated with the maximum signal strength value of the wireless signal strength values, and wherein the at least one memory stores program instructions that, when executed by the at least one processing unit, cause the elevator controller to:
determine the location of the elevator car in the elevator shaft based on the timestamp; and
associate the wireless device with a landing floor corresponding to the location of the elevator car.

23. An elevator controller according to claim 18, wherein the data associated with the recorded wireless signal strength comprises a set of wireless signal strength value and timestamp pairs, and wherein the at least one memory stores program instructions that, when executed by the at least one processing unit, cause the elevator controller to:
determine the maximum wireless signal strength value based on the wireless signal strength values;
determine the location of the elevator car in the elevator shaft based on the timestamp corresponding to the maximum wireless signal strength value; and
associate the wireless device with a landing floor corresponding to the location of the elevator car.

24. An elevator controller according to claim 18, wherein the elevator car mounted wireless device comprises a car operating panel.

25. An elevator controller according to claim 18, wherein the wireless devices comprise at least one of landing call station, a hall lantern indicator and a display.

26. An elevator car mounted wireless apparatus of an elevator system, the apparatus comprising:
at least one processing unit;
at least one memory;
wherein the at least one memory stores program instructions that, when executed by the at least one processing unit, cause the apparatus to:
record data comprising wireless signal strength values and a device identifier based on wireless signals associated with each detected wireless device at landing floors during a travel of the elevator car in an elevator shaft;
associate timestamps for the recorded wireless signal strength values;
determine, for each detected wireless device, the maximum wireless signal strength value of the wireless signal strength values;
determine the location of the elevator car in the elevator shaft based on the timestamp associated with the maximum wireless signal strength value; and
associate the detected wireless device with a landing floor corresponding to the location of the elevator car.

27. An elevator car mounted wireless device according to claim 26, wherein the elevator car mounted wireless device comprises a car operating panel.

28. A landing floor apparatus comprising:
at least one processing unit;
at least one memory;
wherein the at least one memory stores program instructions that, when executed by the at least one processing unit, cause the apparatus to:
receive, from an elevator controller, an instruction to record wireless signals transmitted from an elevator car mounted wireless device;
record wireless signal strength values of wireless signals received from the elevator car mounted wireless device;
associate timestamps for the recorded wireless signal strength values;
send data associated with the wireless signal strength values and the timestamps to the elevator controller; and
in response to sending the data, receive from the elevator controller configuration data that associates the landing floor apparatus to a specific floor.

29. A landing floor apparatus according to claim 28, wherein the data associated with the wireless signal strength values and the timestamps comprises a timestamp associated with the maximum wireless signal strength value of the wireless signal strength values.

30. A landing floor apparatus according to claim 28, wherein the data associated with the wireless signal strength values and the timestamps comprises a set of wireless signal strength value and timestamp pairs.

31. An elevator system comprising:
an elevator car configured to move in an elevator shaft;
an elevator car mounted wireless device;
a plurality of wireless devices at a plurality of landing floors;
an elevator controller of claim 1; and
an elevator car mounted wireless apparatus including,
at least one processing unit,
at least one memory,
wherein the at least one memory stores program instructions that, when executed by the at least one processing unit, cause the apparatus to:
receive, from the elevator controller, an instruction to record wireless signals transmitted from the wireless devices provided at landing floors,
record wireless signal strength values and a device identifier associated with each detected wireless device based on wireless signals from the wireless devices during a travel of the elevator car in an elevator shaft, and
transmit data to the elevator controller, the data including, for each detected wireless device, the device identifier of the detected wireless device and data associated with the wireless signal strength values of the detected wireless device.

32. An elevator system comprising:
an elevator car configured to move in an elevator shaft;
an elevator car mounted wireless device;
a plurality of wireless devices at a plurality of landing floors;
an elevator controller of claim 18; and
a plurality of landing floor apparatuses including,
at least one processing unit;
at least one memory;
wherein the at least one memory stores program instructions that, when executed by the at least one processing unit, cause the apparatus to,
receive, from the elevator controller, an instruction to record wireless signals transmitted from the elevator car mounted wireless device,
record wireless signal strength values of wireless signals received from the elevator car mounted wireless device,
associate timestamps for the recorded wireless signal strength values,
send data associated with the wireless signal strength values and the timestamps to the elevator controller, and
in response to sending the data, receive from the elevator controller configuration data that associates the landing floor apparatus to a specific floor.

33. An elevator system comprising:
an elevator car configured to move in an elevator shaft;
an elevator car mounted wireless device of claim 26;
a plurality of wireless devices at a plurality of landing floors; and
an elevator controller including,
at least one processing unit;
at least one memory;
wherein the at least one memory stores program instructions that, when executed by the at least one processing unit, cause the elevator controller to,
cause the elevator car to travel in the elevator shaft,
cause recording of wireless signal strength values based on wireless signals from the elevator car mounted wireless device with a plurality of wireless devices at the plurality of landing floors during the travel,
receive from the plurality of wireless devices data associated with the recorded wireless signal strength values, and
associate each wireless device with a specific landing floor based on the data received from the wireless devices.

34. A method for configuring wireless devices in an elevator system, the method comprising:
causing an elevator car to perform a travel in an elevator shaft;
causing recording of wireless signal strength values and a device identifier associated with each detected wireless device based on wireless signals from the wireless devices at landing floors with an elevator car mounted wireless device during the travel;
receiving data from the elevator car mounted wireless device, the data comprising for each detected wireless device the device identifier of the detected wireless device and data associated with the wireless signal strength values of the detected wireless device; and
associating each detected wireless device at the landing floors with a specific landing floor based on the data received from the elevator car mounted wireless device.

35. A method for configuring wireless devices in an elevator system, the method comprising:
receiving, from an elevator controller, an instruction to record wireless signals transmitted from wireless devices at landing floors;
recording wireless signal strength values and a device identifier associated with each detected wireless device based on wireless signals from the wireless devices during a travel of the elevator car in an elevator shaft; and
transmitting data to an elevator controller, the data comprising for each detected wireless device the device identifier of the detected wireless device and data associated with the wireless signal strength values of the detected wireless device.

36. A method for configuring wireless devices in an elevator system, the method comprising:
causing an elevator car to perform a travel in an elevator shaft;
causing recording of wireless signal strength values based on wireless signals from an elevator car mounted wireless device with a plurality of wireless devices at a plurality of landing floors during the travel;
receiving from the plurality of wireless devices data associated with the recorded wireless signal strength values; and
associating each wireless device with a specific landing floor based on the data received from the wireless devices.

37. A method for configuring wireless devices in an elevator system, the method comprising:
recording data comprising wireless signal strength values and a device identifier based on wireless signals associated with each detected wireless device at landing floors during a travel of an elevator car in an elevator shaft;
associating timestamps for the recorded wireless signal strength values;
determining, for each detected wireless device, the maximum wireless signal strength value of the wireless signal strength values;
determining the location of the elevator car in the elevator shaft based on the timestamp associated with the maximum wireless signal strength value; and
associating the detected wireless device with a landing floor corresponding to the location of the elevator car.

38. A method for configuring wireless devices in an elevator system, the method comprising:
receiving, with a wireless device from an elevator controller, an instruction to record wireless signals transmitted from an elevator car mounted wireless device;
recording wireless signal strength values of wireless signals received from the elevator car mounted wireless device;
associating timestamps for the recorded wireless signal strength values;
sending data associated with the wireless signal strength values and the timestamps to the elevator controller; and
in response to sending the data, receiving from the elevator controller configuration data that associates the wireless device to a specific floor.

39. A computer program comprising program code, which when executed by at least one processing unit, causes the at least one processing unit to perform the method of claim 34.

40. A computer program according to claim 39, wherein the computer program is embodied on a computer readable medium.
